(19) United States
(12) Patent Application Publication
(10) Pub. No.: US 2008/0223343 A1
(43) Pub. Date: Sep. 18, 2008

(54) Fuel vapor control apparatus

(75) Inventor: Stephan Ammermann, Gottingen (DE)

Correspondence Address: HARNESS, DICKEY & PIERCE, P.L.C., P.O. BOX 828, BLOOMFIELD HILLS, MI, 48303, US

(73) Assignee: A. Kayser Automotive Systems, GmbH, Einbeck (DE)

(21) Appl. No.: 11/716,872

(22) Filed: Mar. 12, 2007

(51) Int. Cl. F02M 35/00

(52) U.S. Cl. 123/520

(57) ABSTRACT

A filter box having an integrated vent solenoid to connect to the atmospheric port of an automotive emission storage canister in relation to the fuel tank of the vehicle, used to recapture fuel vapor before it is released into the atmosphere. The filter box with integrated vent solenoid is sealed to the atmospheric port of the canister, and consists of a filter housing with an internal feature to house and retain a vent solenoid, an optional foam filter to protect the vent solenoid and the canister against dust, and a filter cap to retain the filter foam. A closed cell foam or rubber O-ring provides a sealing between the filter cap and the filter housing. A labyrinth-type filter means is integrated within the cap of the filter box assembly and provides for separation of the air and dust traveling through the filter box, and a further sealing means provides a leak tight seal between the filter box and the canister.

### FIELD

The present disclosure relates to emission control devices for vehicles. More particularly, the present invention relates to a filter box with an integrated vent solenoid to connect to the atmospheric port of an automotive emission storage canister.

### BACKGROUND

The statements in this section merely provide background information related to the present disclosure and may not constitute prior art.

Canisters for storing emissions are provided on automotive vehicles to prevent the discharge of fuel vapors outside vehicles during refueling and normal operation. Often referred to as onboard refueling vapor recovery (ORVR), the typical canister contains activated carbon and is mounted within a vehicle in communication, via a first or vapor inlet port, with the headspace in the fuel tank; via a second or vapor outlet port, with a vacuum source in the engine intake manifold; and via a third or vent port, with the atmosphere outside the vehicle. During refueling, the fill pipe is sealed against vapor leakage, either by a flexible gasket surrounding the fill nozzle or by a liquid seal in the fill pipe. As the tank is filled, air and vapors in the headspace above the fuel are forced through the vapor inlet port into the canister. The vapors are adsorbed onto the charcoal bed, and the air is discharged through the vent port. During subsequent operation of the vehicle, the engine vacuum draws air through the vent port, gradually purging the adsorbed vapors via the vapor outlet port into the engine's combustion flow and preparing the canister for the next refueling. Air also flows back through the vent port into the fuel tank as needed to replace fuel being consumed by the engine.

The air vent port is normally open during periods of non-operation of the vehicle. Fuel tank vapors must be adsorbed by the canister before reaching the vent port. This function is known in the art as diurnal adsorption. Such diurnally adsorbed fuel is also desorbed and conveyed by vacuum to the engine upon startup.

Federal regulations require that each vehicle be equipped to conduct an onboard diagnostic (OBD) leak test of the evaporative emissions system. Several manufacturers use a vacuum decay OBD which requires apparatus for closing off the vapor outlet and vent ports, the vapor inlet port being effectively sealed during test by the fuel tank cap.

Typically, an ORVR canister is mounted immediately adjacent the fuel tank to minimize vapor flow restriction into the canister. Since the fuel tank commonly is located near the rear of the vehicle and the engine at the front, a relatively long hose run is required to connect the canister to the engine intake. A first electric solenoid valve at the canister can close the canister vent port, and a second solenoid valve at the engine can close the vapor outlet line. To test the system for leaks, first the vent port is closed, exposing the system to full engine vacuum, then the outlet line is closed. The OBD system monitors the rate of decay of the captured vacuum.

Mounting the canister at the rear of the vehicle exposes the vent port to dust and debris which, if allowed to enter the canister, can foul the vent solenoid and internal passages, gradually clogging the solenoid valve and the canister and causing failure of the seal test. Entry of dust and debris can also cause operational problems with refueling of the vehicle, including failure to fill properly and premature shutoffs of the refueling nozzle. To prevent such entry, U.S. Pat. No. 5,878,729 issued Mar. 9, 1999 to Covert et al. ('729) and incorporated herein by reference, discloses a canister providing two separate vent ports, an outlet vent port with a check valve for releasing fuel tank air during refueling, and an inlet vent port connected to the downstream side of the engine air filter. An additional check valve is disposed between the inlet vent port and the engine to prevent vapors flowing into the air cleaner during refueling and causing an over rich fuel/air mixture being fed to the engine at start up.

U.S. Pat. No. 6,390,073 issued May 21, 2002 to Meiller et al. ('073) discloses an onboard vapor recovery canister which utilizes a solenoid valve in association with a filter means, but requires attached to the fuel system as a single assembly. Furthermore, the '073 patent operates only with a foam filter and carbon absorption bed. Eventually, a higher pressure drop increase can result after prolonged use of the canister, which can often cause early shut off of a refueling pump nozzle due to backed up fuel vapors in the fuel tank.

### SUMMARY

The present invention overcomes the above short comings in the art, comprising of a filter box having an integrated vent solenoid to connect to the atmospheric port of an automotive emission storage canister in relation to the fuel tank of the vehicle, used to recapture fuel vapor before it is released into the atmosphere. The filter box with integrated vent solenoid is sealed to the atmospheric port of the canister, and consists of a filter housing with an internal feature to house and retain a vent solenoid, an optional dust trap, an optional foam filter to protect the vent solenoid and the canister against dust, and a filter cap to retain the filter foam. A closed cell foam or rubber O-ring provides a sealing between the filter cap and the filter housing. A further sealing means provides a leak tight seal between the filter box and the canister.

It is a further object of the present invention to provide a filter box for use in conjunction with a canister as herein described which is economical to manufacture.

Another object of the present invention is to provide a filter box which provides a universal fit to a plurality of canisters equipped on various vehicles.

Another object of the present invention is to provide a filter box which may optionally be mounted remotely from a canister, having a sealed connection thereto via tube or conduit.

A further object of the present invention is to provide a filter box having a labyrinth interior portion which assists in separating the dust from the gas flow. The filter box may be used as both a labyrinth filter only, or in combination with a foam filter, leading to lower pressure drop increase over time, thereby preventing early shut off of the refueling nozzle during refueling of the fuel tank.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of the filter box attached to a vapor storage canister;

FIG. 2 is a side view of the filter box separated from the vapor storage canister;

FIG. 3 is a first cross sectional view of the filter box attached to a vapor storage canister;

FIG. 4 is a perspective exploded view of the components comprising the filter box of the present invention;

FIG. 5A is first side view of the filter box of the present invention;

FIG. 5B is a second side view of the filter box of the present invention;

FIG. 5C is a first end view of the filter box of the present invention, illustrating the outlet to attach to a canister;

FIG. 5D is a third side view of the filter box of the present invention;

FIG. 5E is a second end view of the filter box of the present invention, illustrating the atmospheric port;

FIG. 6 is a fourth side view of the filter box of the present invention;

FIG. 6A is a cross sectional view of FIG. 6 taken along line 6A;

FIG. 6B is a cross sectional view of FIG. 6 taken along line 6B;

FIG. 7 is the first side view of the filter box of the present invention;

FIG. 7A is a cross sectional view of FIG. 7 taken along line 7A; and

FIG. 7B is a cross sectional view of FIG. 7 taken along line 7B.

### DETAILED DESCRIPTION

The following description is merely exemplary in nature and is not intended to limit the present disclosure, application, or uses. It should be understood that throughout the drawings, corresponding reference numerals indicate like or corresponding parts and features.

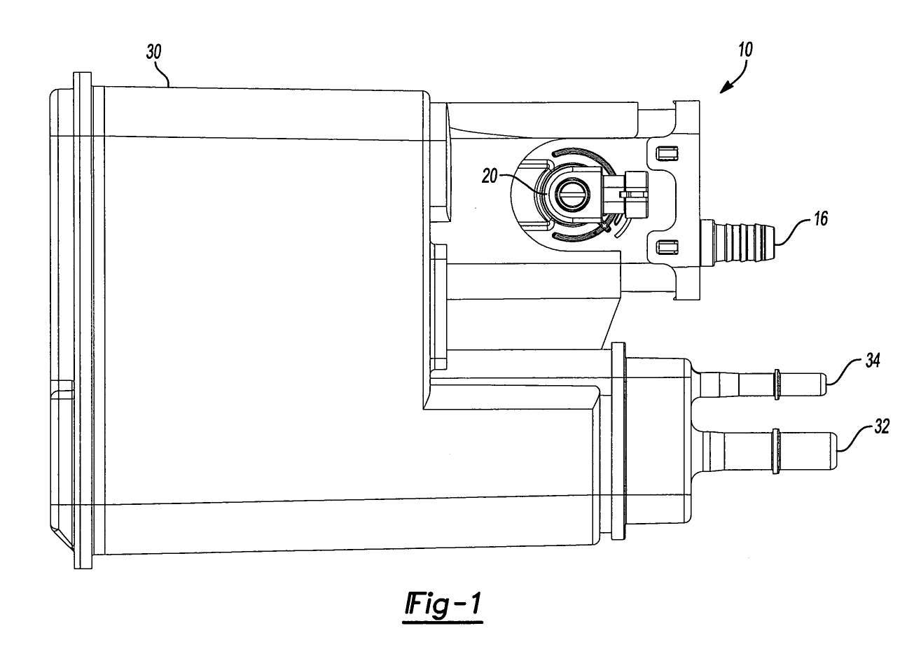

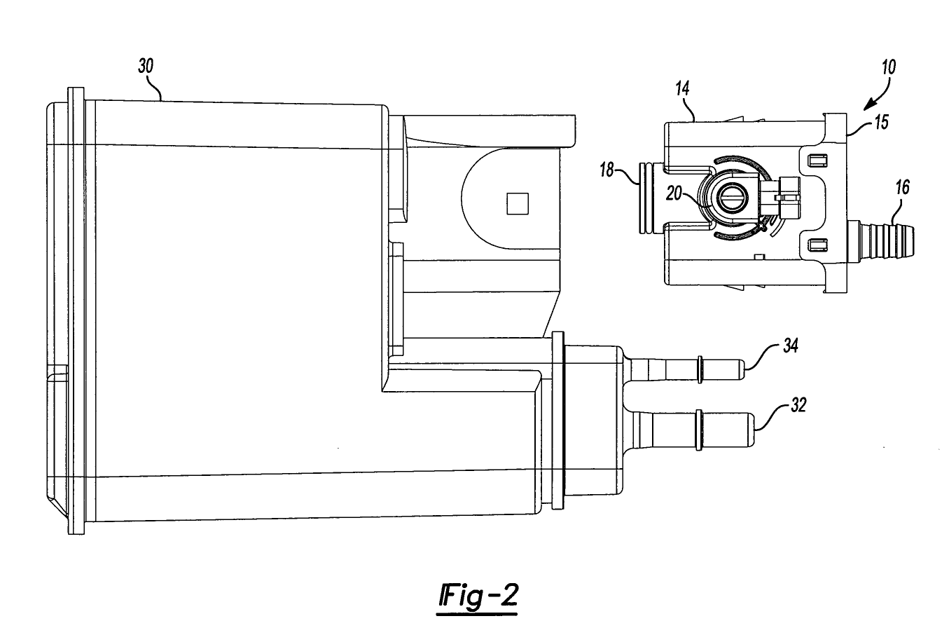

Referring now to the figures, in particular FIGS. 1 and 2, the filter box 10 comprising the present invention is shown attached to a vapor storage canister 30. The canister 30 as mentioned is placed at the end of the vent system of a gasoline fuel tank on a vehicle. The storage canister adsorbs (buffers) the fuel vapors that are released from the fuel tank and enter the canister through the tank port 32 during normal operating or during refueling of the tank. From time to time the canister 30 is purged with clean air via purge port 34, wherein clean air is drawn in through the canister desorbing the fuel vapors and transporting them to the combustion air of the engine.

The filter box 10 with integrated vent solenoid 20 comprises a main housing 14 and is sealingly attached to the atmospheric port of the canister 30 through outlet 18 as part of the evaporative diagnostic known as OBD-II testing. The electrical operated valve seals the fuel tank during the OBD-II testing to check for possible leaks in the complete fuel system. To protect the vent solenoid and the canister against dust, especially during the purge process, the vent solenoid 20 is integrated into the filter box 10. A filter cap 15 is sealingly attached to the opposite end of housing 14 and comprises an atmospheric port 16 therein.

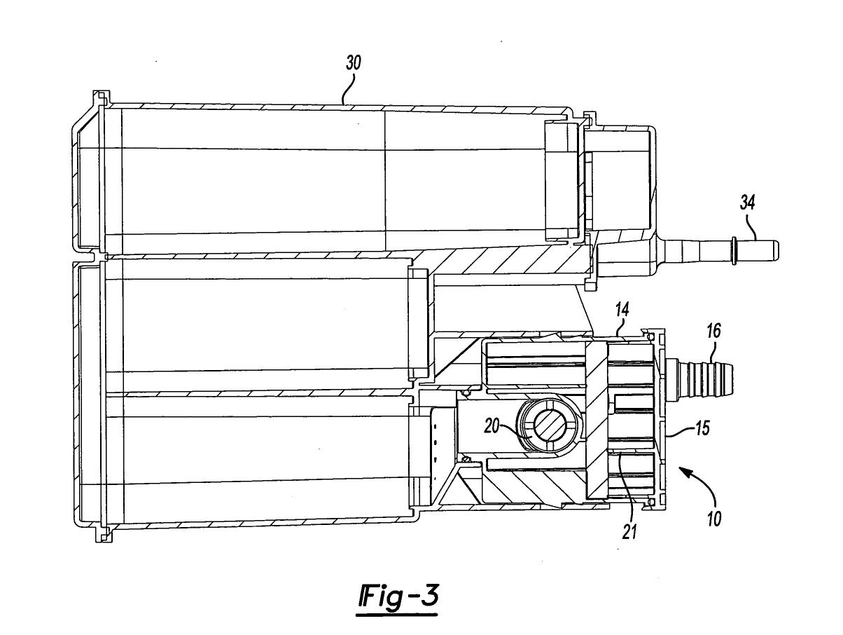

Referring now to FIG. 3, a longitudinal cross-sectional illustration of the filter box 10 attached to canister 30 is shown. The labyrinth walls 21 of cap 15 are apparent in FIG. 3, which provide for a means of separating dust from the gas flow. The advantage of the labyrinth walls 21 is to provide a further filter means (known in the art as a centrifugal-filter) which may be used alone or in combination with a foam filter.

FIG. 4 illustrates an exploded view of the various components comprising the filter box assembly 10. The filter box housing 14 comprises an outlet 18 at one end for connecting with the canister and comprises a grove for retaining a sealing means 19 such as a resilient O-ring. On the top side of the canister housing 14, an aperture 25 sealingly receives the vent solenoid 20 which is locked into place within the housing 14 when assembled. A plurality of locking ramps 17 are integrated in the outside of the filter housing 14 which secure the housing to the canister as shown in FIG. 3.

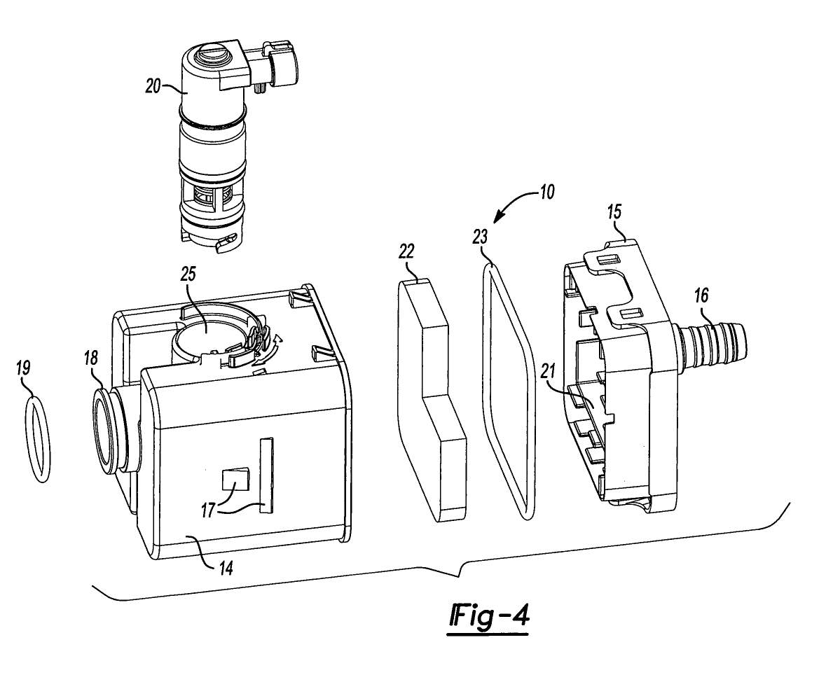

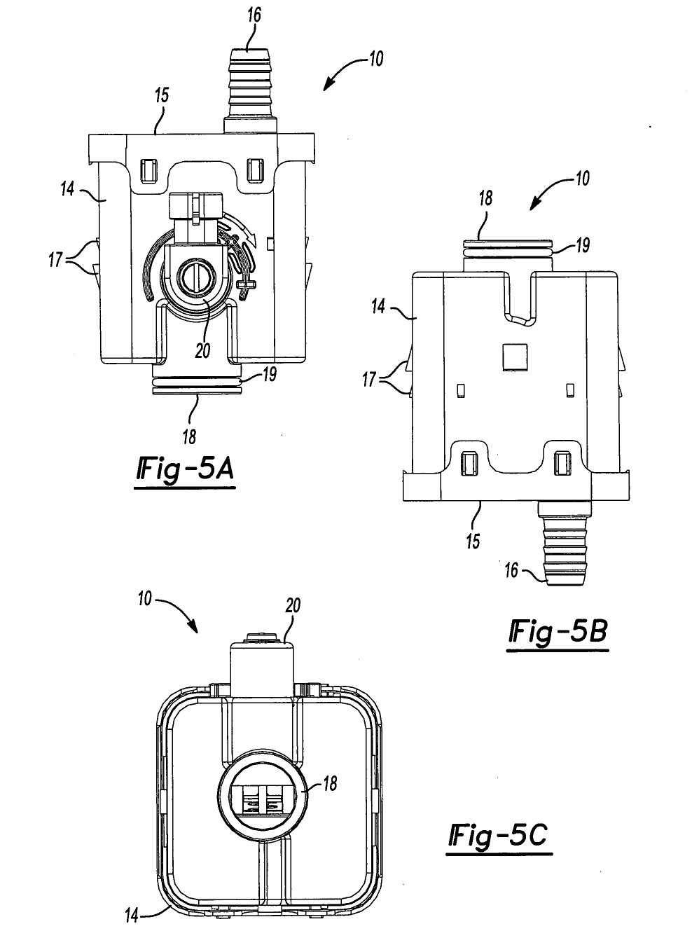

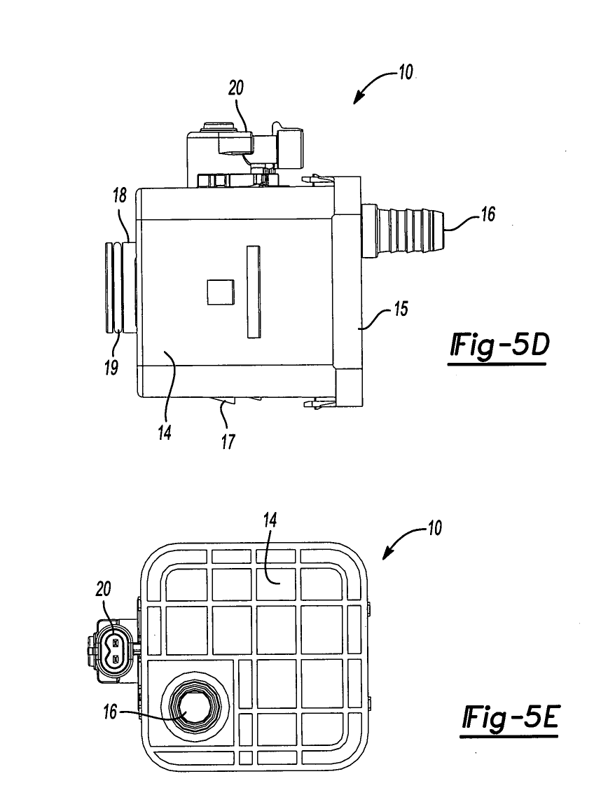

The optional filter foam pad 22 and sealing means 23 are received on the opposite end of the housing 14 from the outlet 18, and are retained in place by filter box cap 15 which is detachably attachable to the housing. The filter box cap 15 as stated above comprises a series of integrated walls 21 which provide a labyrinth-type filtering system for the air which is received through the atmospheric port 16 of the cap 15. FIGS. 5A through 5E, show isolated perspective views of the filter box assembly 10 from each side and end to further illustrate the design and integrated components described herein.

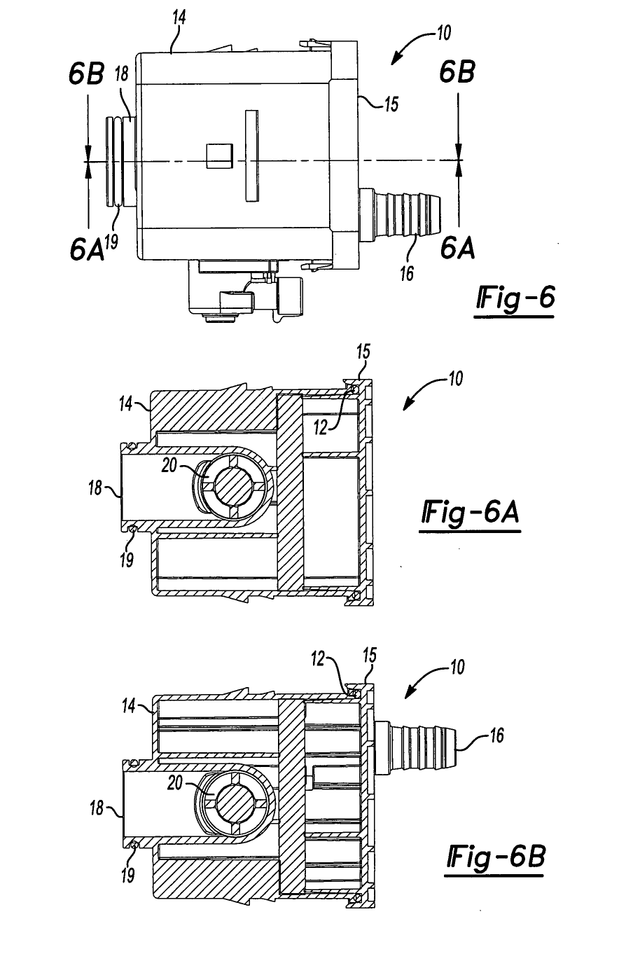

FIGS. 6 through 6B show an isolated, side view of the filter box assembly 10, and two cross-sectional views thereof. From these figures, the sealing means utilized to seal the cap 15 to the housing 14 comprises an O-ring 12, but it is intended to be within the scope of the present invention that any suitable sealing means known in the art may be implemented. Furthermore, the sealing means 19 around the output 18 of the housing 14 also comprises an O-ring and as stated is retained within an annular grove within the output port 18.

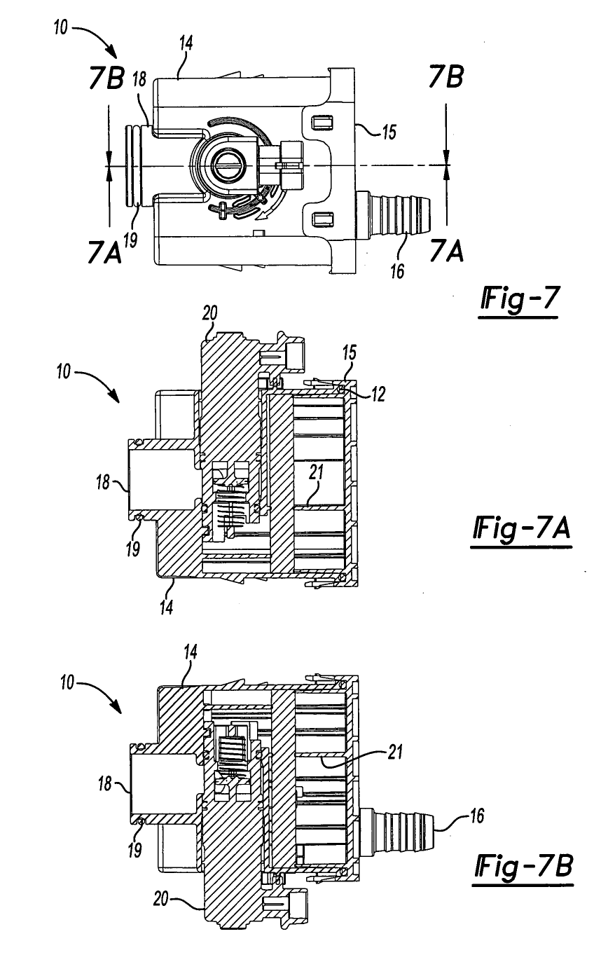

Lastly, FIGS. 7 through 7B show an isolated side view of the filter box assembly 10, and two cross-sectional views thereof. From these illustrations, the position and orientation of the solenoid valve 20 is shown within filter box housing 14 located between the labyrinth filter 21 of the filter box cap 15 and the output port 18 on the opposite side of the housing 14. The solenoid is sealingly received within the filter box housing 14, preventing air and vapor leakage there around during use.

The description of the invention is merely exemplary in nature and, thus, variations that do not depart from the gist of the invention are intended to be within the scope of the invention. Such variations are not to be regarded as a departure from the spirit and scope of the invention.

1. A universally attachable filter box assembly in combination with a fuel vapor recovery canister of an automobile fuel system, said filter box sealingly detachably attaching to the atmosphere port of said canister, said filter box comprising:
a housing, said housing defining an internal volume and having an output at a first end in connection with the atmosphere port of said canister, a means of detachably attaching to said canister, a solenoid receiving aperture and a cap receiving end opposed to said first end;
a cap, said cap sealingly detachably attaching to said cap receiving end of said housing, said cap having a atmospheric port and further comprising an integrated labyrinth on the housing receiving side through which air/fuel vapor travels prior to entering said housing, wherein said atmospheric port comprises a smaller internal diameter than said output at said first end of said housing which is in direct connection with the atmospheric port of said canister;
a solenoid, said solenoid sealingly received within said solenoid receiving aperture of said housing, positioned inline of said volume within said housing, regulating the air traveling through said filter box assembly.

2. The filter box assembly of claim 1 wherein a filter foam pad is positioned inline with said integrated labyrinth of said cap through which air/fuel vapor travels prior to entering said housing.

3. The filter box assembly of claim 1 wherein said output of said housing comprises a sealing means, for sealingly attaching said output to said atmosphere port of said canister.

4. The filter box assembly of claim 1 wherein said cap is sealed to said housing by means of an O-ring positioned there between.

5. The filter box assembly of claim 1 wherein said means of detachably attaching said housing to said canister comprises a hose sealed at a first end to the atmosphere port of said canister, and sealed at a second end to said output of said filter box, allowing vapor communication there between.

6. The filter box assembly of claim 5 wherein said filter box is mounted remotely to said automobile from said canister.

7. The filter box assembly in combination with a fuel vapor recovery canister of an automobile fuel system of claim 1 wherein said filter box assembly universally fits to a plurality of different canisters.
